(19) United States
(12) Patent Application Publication
(10) Pub. No.: US 2026/0229967 A1
(43) Pub. Date: Aug. 6, 2026

(54) STATOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kanzo ISHIHARA, Osaka (JP)

(21) Appl. No.: 19/147,717

(22) PCT Filed: Jan. 9, 2024
(86) PCT No.: PCT/JP2024/000124

§ 371 Date: Jul. 14, 2025

(30) Foreign Application Priority Data
Jan. 25, 2023 (JP) 2023-009104

(51) Int. Cl. H02K 11/33; H02K 1/14

(52) U.S. Cl. CPC H02K 11/33; H02K 1/146; H02K 2211/03

(57) ABSTRACT

It is an object to enable a good understanding of the state of circuitry of a motor, while downsizing the motor. A stator (10) includes a stator core (21), coils (21B, 21C, 21D) attached to the stator core (21), and a plurality of magnetic sensors (31C) configured to output a detection signal that corresponds to magnetism generated by a current flowing through the coils (21B, 21C, 21D). The magnetic sensors (31C) are attached to the stator core (21).

### TECHNICAL FIELD

The present disclosure relates to a stator.

### BACKGROUND

Patent Document 1 discloses a configuration in which a winding switching device is used to switch the connection state of the windings of a three-phase AC motor between parallel winding and series winding.

### PRIOR ART DOCUMENT

### Patent Document

Patent Document 1: JP 2020-162195 A

### SUMMARY OF THE INVENTION

### Problems to Be Solved

The winding switching device of Patent Document 1 has a configuration in which, due to displacement of a movable part of the winding switching device, a conductor part is displaced to switch the electrode to be in contact with the conductor part. In such a configuration, the electrical characteristics of the winding switching device may change due to e.g., wear of the conductor part. To detect such changes, it is conceivable to install a current sensor, a voltage sensor, and the like in the motor. However, if a current sensor and a voltage sensor are installed, the motor tends to have a large external form.

The present disclosure aims to provide a stator that enables a good understanding of the state of the circuitry of a motor while achieving downsizing of the motor.

### Means to Solve the Problem

A stator according to the present disclosure includes a stator core, a coil attached to the stator core and a magnetic sensor configured to output a detection signal that corresponds to magnetism generated by a current flowing through the coil, wherein the magnetic sensor is attached to the stator core.

### Effect of the Invention

According to the present disclosure, a stator enables a good understanding of the state of the circuitry of a motor while achieving downsizing of the motor.

### BRIEF DESCRIPTION OF THE DRAWINGS

FIG. 1 is an exploded perspective view showing a stator according to Embodiment 1.

FIG. 2 is a diagram showing an end face of the stator.

FIG. 3 is a diagram showing a side face of the stator.

FIG. 4 is a cross-sectional view taken along a line A-A in FIG. 3.

FIG. 5 is a circuit diagram showing an example of connection between coil sections and relay switches.

FIG. 6 is a circuit diagram showing an example of connection between coil sections and relay switches according to another embodiment.

### DETAILED DESCRIPTION TO EXECUTE THE INVENTION

Hereinafter, embodiments of the present disclosure are listed and exemplified. Note that the features [1] to [9] exemplified below may be combined in any way as long as they do not contradict each other.
[1] A stator according to the present disclosure includes a stator core, a coil attached to the stator core and a magnetic sensor configured to output a detection signal that corresponds to magnetism generated by a current flowing through the coil, wherein the magnetic sensor is attached to the stator core.

According to the stator of the above-described feature [1], it is easier to reduce the size of the coil, compared to a configuration in which a current sensor and a voltage sensor are attached to a coil.
[2] In the stator of the above-described feature [1], a plurality of the coils may be provided in multiple phases, each of the plurality of coils in the multiple phases may include a plurality of coil sections, the stator may further include a switching part configured to switch connection states of the plurality of coil sections included in each of the coils, and the magnetic sensor may output the detection signal that corresponds to magnetism generated by a current flowing through the coil sections.

The stator of the above-described feature [2] can detect a current that changes according to the connection state.
[3] In the stator of the above-described feature [2], the plurality of coil sections of each of the coils may include a first coil section through which a current flows regardless of the connection state, and a second coil section configured to switch between a conductive state, in which a current flows, and a non-conductive state, in which no current flows, depending on the connection state, and the magnetic sensor may output the detection signal that corresponds to magnetism generated by a current flowing through the second coil section.

In the stator of the above-described feature [3], it is easier to understand the switching of the connection state based on the detection signal.
[4] In the stator of the above-described feature [3], the stator core may include an annular yoke section and a plurality of teeth sections that have a shape protruding in a radial direction of the yoke section from one of an inner circumferential edge and an outer circumferential edge of the yoke section and are lined up at the one circumferential edge around an axis of the yoke section, and the first coil section and the second coil section may have a configuration in which they are wound on different teeth sections.

The stator of the above-described feature [4] easily detects only the current flowing through the second coil section.
[5] The stator of any one of the above-described features [2] to [4] may further include an output line to which the detection signal is applied and a circuit board to which the output line is connected and on which the switching part is mounted, wherein the magnetic sensor may be connected to the circuit board via the output line.

In the stator of the above-described feature [5], it is easy to simplify wiring.
[6] In the stator of any one of the above-described features [1] to [4], a recess may be formed in a surface of the stator core, and at least part of the magnetic sensor may be housed in the recess.

The stator of the above-described feature [6] can be downsized more easily.
[7] In the stator of the above-described feature [6], the stator core may include an annular yoke section and a plurality of teeth sections that have a shape protruding in a radial direction of the yoke section from one of an inner circumferential edge and an outer circumferential edge of the yoke section and are lined up at the one circumferential edge around an axis of the yoke section, and the recess may be formed in the other one of the inner circumferential edge and the outer circumferential edge and may have a groove shape extending along an axial direction of the stator core.

In the stator of the above-described feature [7], the groove-shaped recess, which functions as a guide in the axial direction, can be used to secure a housing space for the magnetic sensor.
[8] In the stator of any one of the above-described features [1] to [4], the stator core may include an annular yoke section and a plurality of teeth sections that have a shape protruding in a radial direction of the yoke section from one of an inner circumferential edge and an outer circumferential edge of the yoke section and are lined up at the one circumferential edge around an axis of the yoke section, the coil may include wound sections that are wound on the respective teeth sections, and the magnetic sensor is positioned on an inner side relative to an inner circumference of a detection target wound section in a planar direction orthogonal to an axial direction of the wound section.

The stator according to the above-described feature [8] easily detects magnetism generated by a current flowing through the wound section to be detected.
[9] In the stator of any one of the above-described features [1] to [4], the stator core may include an annular yoke section and a plurality of teeth sections that have a shape protruding toward an axis of the yoke section from an inner circumferential edge of the yoke section and are lined up at the inner circumferential edge around the axis of the yoke section, and the magnetic sensor may be attached to the outer circumferential edge of the yoke section.

In the stator of the above-described feature [9], the magnetic sensor can be easily installed.

### Embodiment 1

### Configuration of Motor

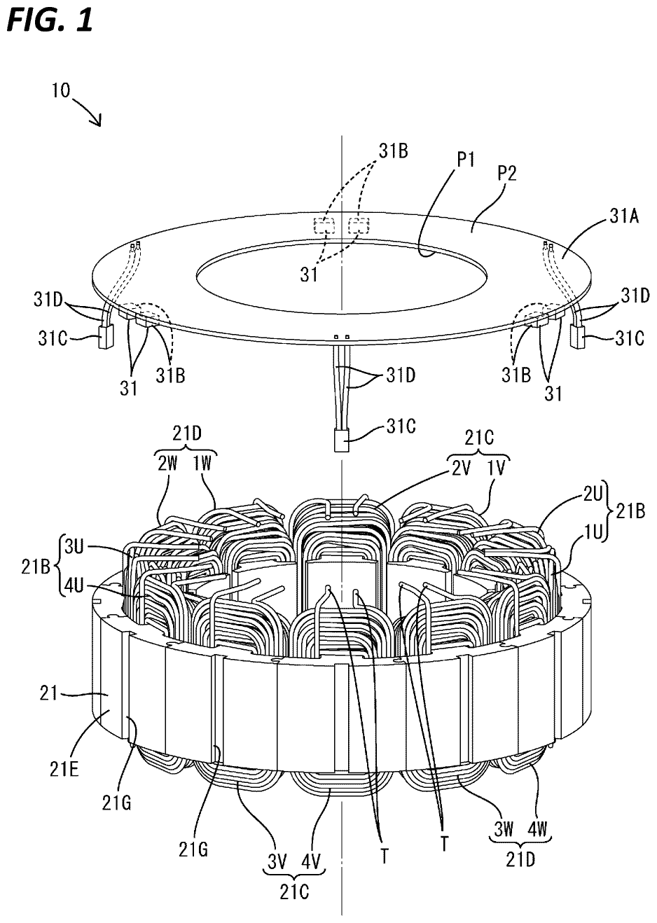

A motor in which a stator 10 of Embodiment 1 is used is a multi-phase motor that uses a multi-phase AC power supply. As shown in FIG. 1, the stator 10 includes a stator core 21, a plurality of coils 21B, 21C, and 21D, a circuit board 31A, a switching part 31, and a plurality of magnetic sensors 31C.

### Configuration of Stator Core

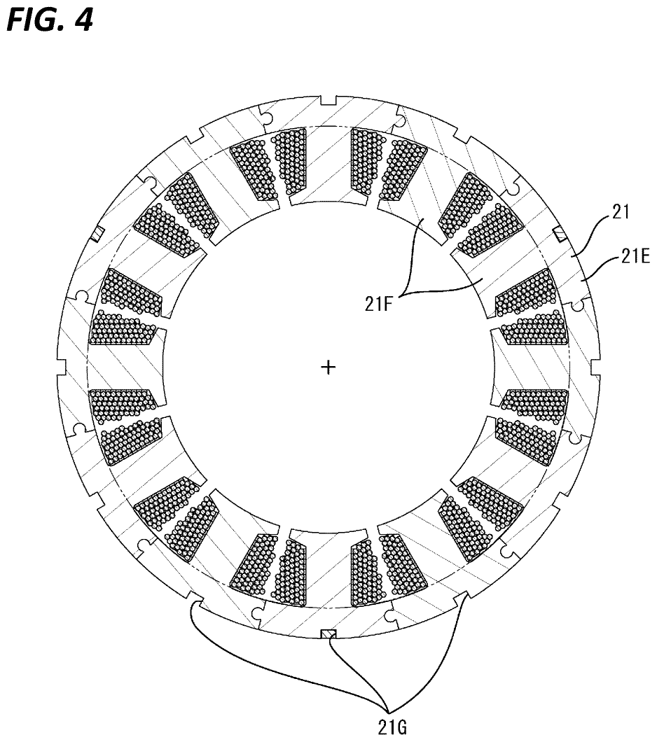

As shown in FIG. 4, the stator core 21 includes an annular yoke section 21E and a plurality of teeth sections 21F. The yoke section 21E and the teeth sections 21F are formed in one piece. The yoke section 21E and the teeth sections 21F are made of conductive metal. The teeth sections 21F have a shape protruding from the inner circumferential edge of the yoke section 21E toward the axis of the yoke section 21E. The plurality of teeth sections 21F are lined up at predetermined intervals at the inner circumferential edge of the yoke section 21E around the axis of the yoke section 21E.

A plurality of recesses 21G are formed in the outer circumferential surface (surface) of the yoke section 21E of the stator core 21. These recesses 21G are formed in the outer circumferential edge of the yoke section 21E. The recesses 21G extend along the axial direction of the yoke section 21E and are groove-shaped in a manner such that they are depressed toward the axis of the yoke section 21E (see FIG. 1). Each recess 21G is arranged corresponding to a teeth section 21F. Specifically, the recesses 21G are lined up in a radial direction of the teeth sections 21F that is orthogonal to the axis of the yoke section 21E.

### Configuration of Coil

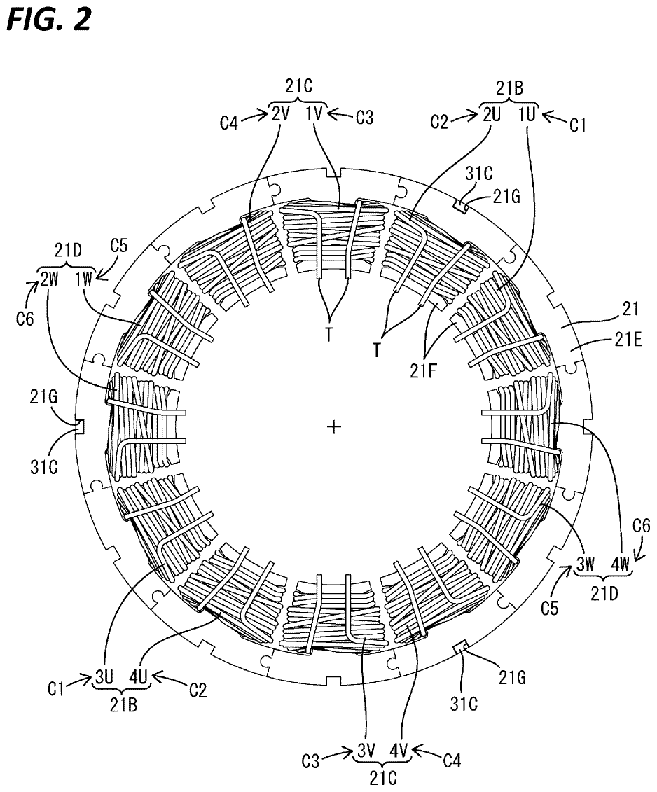

As shown in FIG. 2, the plurality of coils 21B, 21C, and 21D are each configured as a three-phase segment coil. The coils 21B, 21C, and 21D are in the form of so-called concentrated winding. The coil 21B corresponds to a first phase (U phase), the coil 21C corresponds to a second phase (V phase), and the coil 21D corresponds to a third phase (W phase). The coil 21B of the first phase (U phase) includes coil sections, which are wound sections, 1U, 3U, 2U, and 4U. The coil 21C of the second phase (V phase) includes coil sections, which are wound sections, 1V, 3V, 2V, and 4V. The coil 21D of the third phase (W phase) includes coil sections, which are wound sections, 1W, 3W, 2W, and 4W.

Each of the coil sections 1U, 3U, 2U, 4U, 1V, 3V, 2V, 4V, 1W, 3W, 2W, and 4W (hereinafter referred to simply as a coil section group C) is composed of a wire wound in a spiral shape (coil shape) on the corresponding teeth section 21F of the stator core 21. The coil section group C is arranged such that the coil sections are lined up annularly along the inner circumference of the yoke section 21E. The coil section group C is arranged with the axis of each coil section orthogonal to the winding direction thereof oriented in a direction orthogonal to the center line of the stator core 21.

Each of the coil sections 1U, 3U, 2U, 4U, 1V, 3V, 2V, 4V, 1W, 3W, 2W, and 4W has a pair of terminal ends T. Each of the terminal ends T is drawn out to one side of the yoke section 21E in the axial direction (see FIG. 1).

### Configuration of Circuit Board

The circuit board 31A is made of, for example, glass epoxy resin. As shown in FIG. 1, the circuit board 31A is annular. A conductive circuit pattern (not shown) is formed on one board face P1 and another board face P2 of the circuit board 31A. The circuit board 31A is arranged with the one board face P1 facing an end face of the stator core 21 on the side from which the terminal ends T are drawn out.

### Configuration of Switching Part

The switching part 31 is constituted by a plurality of relay switches 31B. The plurality of relay switches 31B are configured as semiconductor relays. The semiconductor relays are each composed of, for example, a MOSFET, GaNFET, IGBT, bipolar transistor, or the like. Each relay switch 31B is configured to be switched between the on state and the off state by an on or off instruction based on a control signal from a control device (not shown). Each of the relay switches 31B enters the on state in response to the on instruction from the control device, allowing a current to flow through that relay switch 31B, and enters the off state in response to the off instruction from the control device, interrupting a current flow through that relay switch 31B.

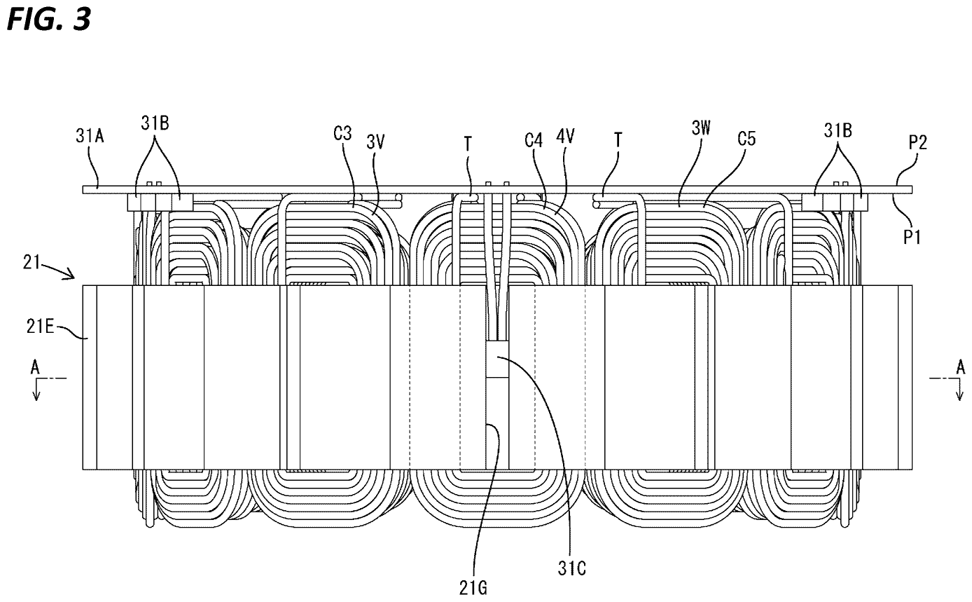

Each relay switch 31B is fixed by solder to the circuit pattern formed on the one board face P1 of the circuit board 31A, for example. In this way, the switching part 31 is attached to the circuit board 31A. The relay switches 31B are arranged between the circuit board 31A and the stator core 21 (see FIG. 3).

### Configuration of Connection Between Coil Section and Switching Part

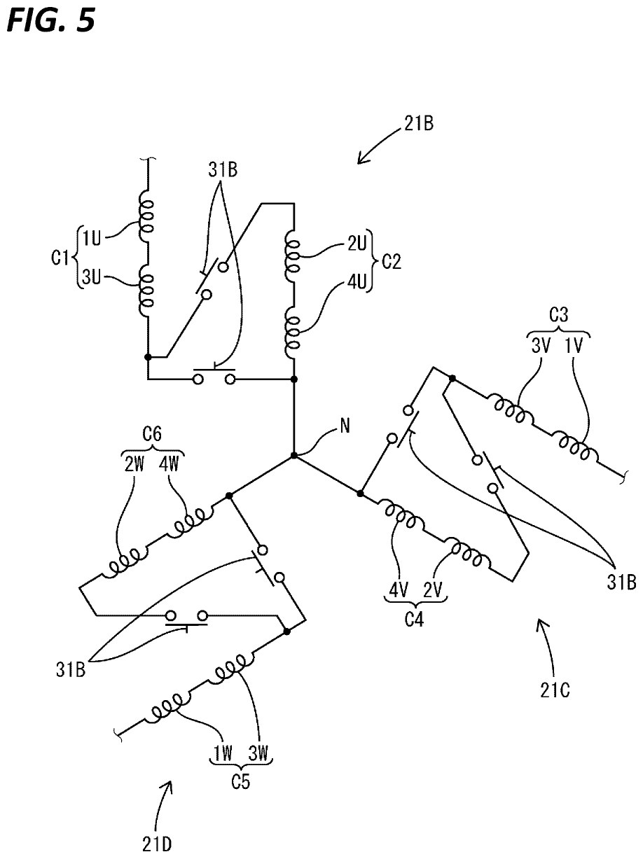

Each terminal end T is fixed, for example, by solder to the circuit pattern formed on the one board face P1 of the circuit board 31A (see FIG. 3). The coil section group C and the relay switches 31B are electrically connected via the circuit board 31A in the configuration shown in FIG. 5, for example. Specifically, the plurality of coils 21B, 21C, and 21D are electrically connected to each other so that they are continuous with each other radially from a neutral section N.

In the present disclosure, the expression “electrically connected” preferably refers to a configuration in which both connection targets are connected to each other in a conductive state (in which a current is allowed to flow) so as to have equal potential. However, the expression is not limited to this configuration. For example, the expression “electrically connected” may refer to a configuration in which both connection targets are connected to each other so as to be in a state in which they are conductive, with an electrical component interposed therebetween.

In the coil 21B, two relay switches 31B are electrically connected to a first coil section C1, in which the coil sections 1U and 3U are electrically connected in series, and to a second coil section C2, in which the coil sections 2U and 4U are electrically connected in series. In the coil 21B, one of the relay switches 31B is provided between a second end of the first coil section C1 and a second end of the second coil section C2, and the other relay switch 31B is provided between the second end of the first coil section C1 and a first end of the second coil section C2.

In the coil 21C, two relay switches 31B are electrically connected to a first coil section C3, in which the coil sections 1V and 3V are electrically connected in series, and to a second coil section C4, in which the coil sections 2V and 4V are electrically connected in series. In the coil 21C, one of the relay switches 31B is provided between a second end of the first coil section C3 and a second end of the second coil section C4, and the other relay switch 31B is provided between the second end of the first coil section C3 and a first end of the second coil section C4.

In the coil 21D, two relay switches 31B are electrically connected to a first coil section C5, in which the coil sections 1W and 3W are electrically connected in series, and to a second coil section C6, in which the coil sections 2W and 4W are electrically connected in series. In the coil 21D, one of the relay switches 31B is provided between a second end of the first coil section C5 and a second end of the second coil section C6, and the other relay switch 31B is provided between the second end of the first coil section C5 and a first end of the second coil section C6.

The first ends of the first coil sections C1, C3, and C5 are electrically connected to a not-shown inverter. In Embodiment 1, two relay switches 31B are provided for each phase. Therefore, six relay switches 31B in total are used in Embodiment 1. Each of the coil sections 1U, 3U, 2U, 4U, 1V, 3V, 2V, 4V, 1W, 3W, 2W, and 4W is wound on one teeth section 21F (see FIG. 2). Therefore, the first coil sections C1, C3, and C5 and the second coil sections C2, C4, and C6 are wound on different teeth sections 21F.

For example, the relay switches 31B between the second ends of the respective first coil sections C1, C3, and C5 and the second ends of the respective second coil sections C2, C4, and C6 are turned off by the not-shown control device. Along with this, the relay switches 31B between the second ends of the respective first coil sections C1, C3, and C5 and the first ends of the respective second coil sections C2, C4, and C6 are turned on. This allows the first and second coil sections C1 and C2 to be connected in series with each other, the first and second coil sections C3 and C4 to be connected in series with each other, and the first and second coil sections C5 and C6 to be connected in series with each other.

In contrast, the relay switches 31B between the second ends of the respective first coil sections C1, C3, and C5 and the second ends of the respective second coil sections C2, C4, and C6 are turned on. Along with this, the relay switches 31B between the second ends of the respective first coil sections C1, C3, and C5 and the first ends of the respective second coil sections C2, C4, and C6 are turned off. This allows a current to flow in the first coil sections C1, C3, and C5 and to prevent a current from flowing in the second coil sections C2, C4, and C6. In this way, the switching part 31 can change the characteristics of the motor by switching the connection state of the coil section group C in the coils 21B, 21C, and 21D. The first coil sections C1, C3, and C5 are configured to allow a current to flow regardless of the connection state. The second coil sections C2, C4, and C6 are configured to switch between a conductive state, in which a current flows, and a non-conductive state, in which no current flows, depending on the connection state. The switching part 31 changes the number of series connections in each of the coils 21B, 21C, and 21D by switching the connection state of the coil section group C in the coils 21B, 21C, and 21D.

### Configuration of Magnetic Sensor

Magnetic sensing elements such as Hall elements or magnetoresistive elements are used as the magnetic sensors 31C. The magnetic sensors 31C are configured to be able to output detection signals corresponding to magnetism generated by a current flowing through the coils 21B, 21C, and 21D. As shown in FIG. 1, each magnetic sensor 31C is electrically connected to the circuit board 31A via a pair of output lines 31D. For example, one terminal end of each output line 31D is inserted into a through hole formed in the circuit board 31A and is fixed by solder to a circuit pattern formed on the other board face P2 of the circuit board 31A. A detection signal output from the magnetic sensor 31C is applied to the pair of output lines 31D and is transmitted to the circuit board 31A via the output lines 31D.

As shown FIG. 2, the magnetic sensors 31C are attached to the outer circumferential edge of the yoke section 21E of the stator core 21. Specifically, the magnetic sensors 31C are respectively housed in recesses 21G that correspond to the teeth sections 21F on which the second coil sections C2, C4, and C6 are wound. The second coil sections C2, C4, and C6 are targets to be detected by the magnetic sensors 31C. In Embodiment 1, the magnetic sensors 31C are respectively housed in the recesses 21G that correspond to the teeth sections 21F on which the coil sections 2U, 4V, and 2W included in the second coil sections C2, C4, and C6 are wound.

The magnetic sensor 31C are respectively positioned on an inner side relative to the inner circumference of the second coil sections C2, C4, and C6 in a planar direction orthogonal to the axial direction of the second coil sections C2, C4, and C6, which are targets to be detected (see FIG. 3). FIG. 3 shows a state where the magnetic sensor 31C is arranged inside the inner circumference of the second coil section C4 in a planar direction orthogonal to the axial direction of the second coil section C4. As a result, each magnetic sensor 31C smoothly detects magnetism caused by a current flowing through the corresponding second coil section C2, C4, or C6 and outputs a detection signal that corresponds to the detected magnetism.

The stator 10 thus formed is housed in a not-shown cylindrical housing in a coaxial orientation with respect to the housing. When the stator 10 is housed in the housing, the recesses 21G of the stator core 21 are held by a holding part (not shown) of an automatic machine that assembles the motor. With this, the circumferential position of the stator 10 is determined, making it possible to repeatedly perform operation of inserting the stator 10 into the housing always in a constant orientation. The outer circumferential surface of the yoke section 21E is in contact with the inner circumferential surface of the housing. With this, the stator 10 is fixed to the housing.

The following describes examples of effects of this configuration.

The stator 10 includes the stator core 21, the coils 21B, 21C, and 21D attached to the stator core 21, and the plurality of magnetic sensors 31C that output detection signals corresponding to magnetism generated by a current flowing through the coils 21B, 21C, and 21D. The magnetic sensors 31C are attached to the stator core 21. According to this configuration, the sizes of the coils 21B, 21C, and 21D can be reduced easily, compared to a configuration in which current sensors and voltage sensors are attached to the coils 21B, 21C, and 21D.

In the stator 10, the coils 21B, 21C, and 21D are provided in multiple phases, and the coils 21B, 21C, and 21D in the multiple phases have the plurality of coil sections 1U, 3U, 2U, 4U, 1V, 3V, 2V, 4V, and 1W, 3W, 2W, 4W. The stator 10 further includes the switching part 31 that switches the connection states of the plurality of coil sections 1U, 3U, 2U, 4U, 1V, 3V, 2V, 4V, and 1W, 3W, 2W, 4W in the coils 21B, 21C, and 21D. The magnetic sensors 31C output detection signals corresponding to magnetism generated by a current flowing through the coil sections 2U, 4U, 2V, 4V, and 2W, 4W. According to this configuration, it is possible to detect a current that changes according to the connection state.

In the stator 10, the plurality of coil sections 1U, 3U, 2U, 4U, 1V, 3V, 2V, 4V, and 1W, 3W, 2W, 4W of each of the coils 21B, 21C, and 21D include the first coil section C1, C3, C5 and the second coil section C2, C4, C6. A current flows through the first coil sections C1, C3, and C5 regardless of the connection state. The second coil sections C2, C4, and C6 switches between the conductive state, in which a current flows, and the non-conductive state, in which no current flows, depending on the connection state. The magnetic sensors 31C output detection signals corresponding to magnetism generated by a current flowing through the second coil sections C2, C4, and C6. According to this configuration, it is easier to understand the switching of the connection state based on the detection signal.

In the stator 10, the stator core 21 includes the annular yoke section 21E, and the plurality of teeth sections 21F that have a shape protruding inwardly in the radial direction of yoke section 21E from the inner circumferential edge of the yoke section 21E and are lined up at the inner circumferential edge around the axis of the yoke section 21E. The first coil sections C1, C3, and C5 and the second coil sections C2, C4, and C6 have a configuration in which they are wound on different teeth sections 21F. According to this configuration, only the current flowing through the second coil sections C2, C4, and C6 can be easily detected.

The stator 10 includes the output lines 31D to which detection signals are applied, and the circuit board 31A to which the output lines 31D are connected and on which the switching part 31 is mounted, and the magnetic sensors 31C are connected to the circuit board 31A via the output lines 31D. According to this configuration, it is easy to simplify wiring.

In the stator 10, recesses 21G are formed in the surface of the stator core 21, and the magnetic sensors 31C are housed in the respective recesses 21G. According to this configuration, a downsized motor can be realized more easily.

In the stator 10, the stator core 21 includes the annular yoke section 21E, and the plurality of teeth sections 21F that have a shape protruding inwardly in the radial direction of yoke section 21E from the inner circumferential edge of the yoke section 21E and are lined up at the inner circumferential edge around the axis of the yoke section 21E. The recesses 21G are formed in the outer circumferential edge of the yoke section 21E and has a groove shape extending along the axial direction of the stator core 21. According to this configuration, the groove-shaped recesses 21G, which function as guides in the axial direction, can be used to secure a housing space for the magnetic sensors 31C.

In the stator 10, the stator core 21 includes the annular yoke section 21E, and the plurality of teeth sections 21F that have a shape protruding inwardly in the radial direction of yoke section 21E from the inner circumferential edge of the yoke section 21E and are lined up at the inner circumferential edge around the axis of the yoke section 21E. The coils 21B, 21C, and 21D include the coil sections 1U, 3U, 2U, 4U, 1V, 3V, 2V, 4V, and 1W, 3W, 2W, 4W (wound sections) wound around the respective teeth sections 21F. The magnetic sensors 31C are positioned on an inner side relative to the inner circumference of the coil sections 2U, 4V, and 2W (wound sections) in a planar direction orthogonal to the axial direction of the coil sections 2U, 4V, and 2W (wound sections), which are targets to be detected. According to this configuration, it is easy to detect magnetism generated by a current flowing through the coil sections 2U, 4V, and 2W, which are targets to be detected.

In the stator 10, the stator core 21 includes the annular yoke section 21E, and the plurality of teeth sections 21F that have a shape protruding toward the axis of the yoke section 21E from the inner circumferential edge of the yoke section 21E and are lined up at the inner circumferential edge around the axis of the yoke section 21E. The magnetic sensors 31C are attached to the outer circumferential edge of the yoke section 21E. This configuration makes it easier to install the magnetic sensors 31C.

### Other Embodiments

The embodiments disclosed herein are in all respects to be considered illustrative and not restrictive. The scope of the invention is not limited to the embodiments disclosed herein, but is indicated by the claims, which are intended to include all modifications within the meaning and scope equivalent to the claims.

In contrast to Embodiment 1, a configuration is also possible in which part of each magnetic sensor is housed in the corresponding recess.

In contrast to Embodiment 1, a configuration is also possible in which the magnetic sensors are housed in the recesses that correspond to the teeth sections on which the first coil sections are wound. Also, a configuration is possible in which magnetic sensors are housed in the recesses regardless of whether the recesses are formed in the first coil section or the second coil section. With this, the magnetic sensor may output detection signals corresponding to magnetism generated by a current flowing through the coil section.

In contrast to Embodiment 1, the present disclosure may be applied to a stator of an outer rotor type. Specifically, a plurality of teeth sections are provided that have a shape protruding outwardly in the radial direction of the annular yoke section from the outer circumferential edge of the yoke section and are lined up around the axis of the yoke section. Then, recesses are provided in the inner circumferential edge of the yoke section so as to be depressed outward in the radial direction of the yoke section, and magnetic sensors are provided in the respective recesses.

In contrast to Embodiment 1, the circuit board may be disc shaped. In this case, the rotor is formed protruding to only one side of the housing.

Although Embodiment 1 has described a configuration in which each of the U phase, V phase, and W phase coils includes four coil sections, the number of coil sections in each coil is not limited to this number.

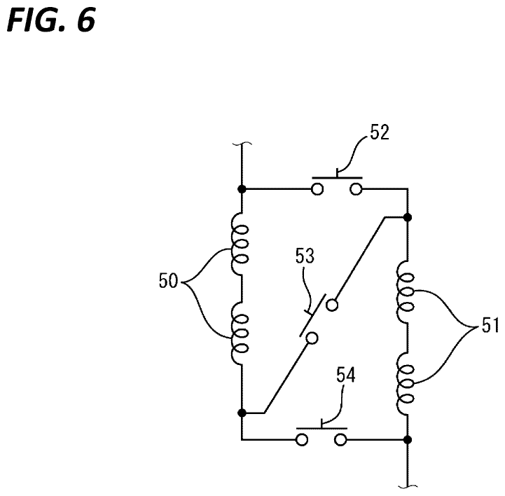

The number of relay switches is not limited to the number disclosed in Embodiment 1. For example, as shown in FIG. 6, a configuration is also possible in which a first coil section 50 and a second coil section 51 are connected to each other by three relay switches 52, 53, and 54. In this configuration, the first coil section 50 and the second coil section 51 can be connected in series by turning off the relay switches 52 and 54 and turning on the relay switch 53. In contrast, the first coil section 50 and the second coil section 51 can be connected in parallel by turning on the relay switches 52 and 54 and turning off the relay switch 53. In this configuration, by switching the relay switches 52, 53, and 54, the connection state of the first coil section 50 and the second coil section 51 can be switched between series connection and parallel connection.

In contrast to Embodiment 1, the coils may be of distributed winding. In the case of distributed winding, a magnetic sensor may be arranged at a position where the magnetism of the first and second coil sections is detected.

### List of Reference Numerals

1U, 1V, 1W, 2U, 2V, 2W, 3U, 3V, 3W, 4U, 4V, 4W . . . Coil section (wound section)
10 . . . Stator
21 . . . Stator core
21B, 21C, 21D . . . Coil
21E . . . Yoke section
21F . . . Teeth section
21G . . . Recess
31 . . . Switching part
31A . . . Circuit board
31B, 52, 53, 54 . . . Relay switch
31C . . . Magnetic Sensor
31D . . . Output line
C . . . Coil section group
C1, C3, C5, 50 . . . First coil section
C2, C4, C6, 51 . . . Second coil section
N . . . Neutral section
P1 . . . Board face
T . . . Terminal end

1. A stator comprising:
a stator core;
a coil attached to the stator core; and
a magnetic sensor configured to output a detection signal that corresponds to magnetism generated by a current flowing through the coil,
wherein the magnetic sensor is attached to the stator core,
a plurality of the coils are provided in multiple phases,
each of the plurality of coils in the multiple phases includes a plurality of coil sections,
the stator further comprises a switching part configured to switch connection states of the plurality of coil sections included in each of the coils,
the magnetic sensor outputs the detection signal that corresponds to magnetism generated by a current flowing through the coil sections,
the plurality of coil sections of each of the coils include a first coil section through which a current flows regardless of the connection state, and a second coil section configured to switch between a conductive state, in which a current flows, and a non-conductive state, in which no current flows, depending on the connection state, and
the magnetic sensor outputs the detection signal that corresponds to magnetism generated by a current flowing through the second coil section.

2. (canceled)

3. (canceled)

4. The stator according to claim 1,
wherein the stator core includes:
an annular yoke section; and
a plurality of teeth sections that have a shape protruding in a radial direction of the yoke section from one of an inner circumferential edge and an outer circumferential edge of the yoke section and are lined up at the one circumferential edge around an axis of the yoke section, and
the first coil section and the second coil section have a configuration in which they are wound on different teeth sections.

5. The stator according to claim 1, further comprising:
an output line to which the detection signal is applied; and
a circuit board to which the output line is connected and on which the switching part is mounted,
wherein the magnetic sensor is connected to the circuit board via the output line.

6. The stator according to claim 1,
wherein a recess is formed in a surface of the stator core, and
at least part of the magnetic sensor is housed in the recess.

7. The stator according to claim 6,
wherein the stator core includes:
an annular yoke section; and
a plurality of teeth sections that have a shape protruding in a radial direction of the yoke section from one of an inner circumferential edge and an outer circumferential edge of the yoke section and are lined up at the one circumferential edge around an axis of the yoke section, and
the recess is formed in the other one of the inner circumferential edge and the outer circumferential edge and has a groove shape extending along an axial direction of the stator core.

8. The stator according to claim 1,
wherein the stator core includes:
an annular yoke section; and
a plurality of teeth sections that have a shape protruding in a radial direction of the yoke section from one of an inner circumferential edge and an outer circumferential edge of the yoke section and are lined up at the one circumferential edge around an axis of the yoke section,
the coil includes wound sections that are wound on the respective teeth sections, and
the magnetic sensor is positioned on an inner side relative to an inner circumference of a detection target wound section in a planar direction orthogonal to an axial direction of the wound section.

9. The stator according to claim 1,
wherein the stator core includes:
an annular yoke section; and
a plurality of teeth sections that have a shape protruding toward an axis of the yoke section from an inner circumferential edge of the yoke section and are lined up at the inner circumferential edge around the axis of the yoke section, and
the magnetic sensor is attached to the outer circumferential edge of the yoke section.
